(19) United States
(12) Patent Application Publication
(10) Pub. No.: US 2008/0212208 A1
(43) Pub. Date: Sep. 4, 2008

(54) LENS SET ADAPTED TO WEBCAM

(75) Inventors: Liang Yu YAO, Jhonghe City (TW); Chun Chung HUANG, Taipei City (TW); Tsai Jung HU, Pingjhen City (TW); Jung Ying YAO, Taoyuan City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: DARFON ELECTRONICS CORP., Taoyuan (TW)

(21) Appl. No.: 12/040,400

(22) Filed: Feb. 29, 2008

(30) Foreign Application Priority Data
Mar. 2, 2007 (TW) 096203487

(51) Int. Cl. G02B 9/04

(52) U.S. Cl. 359/793

(57) ABSTRACT

The invention discloses a lens set adapted to a webcam. The webcam has a first focal length. The lens set according to the invention includes a first lens and a second lens. The first lens is used to refract a light to generate a refracted light substantially parallel to an optical axis of the first lens. The second lens is used to focus the refracted light and project it to the webcam. The combination of the lens set and the webcam has a second focal length smaller than the first focal length.

### CROSS-REFERENCE TO RELATED APPLICATIONS

This non-provisional application claims priority under 35 U.S.C. § 119(a) on Patent Application No(s). 096203487 filed in Taiwan, R.O.C. on Mar. 2, 2007, the entire contents of which are hereby incorporated by reference.

### BACKGROUND OF THE INVENTION

1. Field of the Invention

The invention relates to a lens set and, more particularly, to a lens set adapted to a webcam.

2. Description of the Prior Art

Conventional webcams are usually used to perform video function via instant communication applications, such as MSN or SKYPE. Please refer to FIG. 1. FIG. 1 is a schematic diagram illustrating a capturing mode of a webcam 10 in prior art. As shown in FIG. 1, because the focal length D and acquirable angle of the webcam 10 are usually very large, the webcam 10 can capture an image 12 at a larger angle, such as 60 degrees. However, the webcam 10 is unable to clearly capture an image located at or within the focal length D. In other words, the webcam 10 is unable to clearly capture fine words or details of the image 12.

On the other hand, when a user desires to instantly record some data, such as a business card, an account of a credit card, a shopping invoice and so on, he/she can utilize a digital camera to take a photo of the data. However, if the user wants to further save or process the data captured by the digital camera, he/she has to transmit the data from the digital camera to a computer. For this reason, the extraneous transmitting procedure is inconvenient for the user.

Since it is becoming a tendency to install a webcam in a laptop, the main scope of the invention is to provide a lens set adapted to a webcam, so as to solve the aforesaid problems.

### SUMMARY OF THE INVENTION

A scope of the invention is to provide a lens set adapted to a webcam. The webcam has a first focal length. According to a preferred embodiment of the invention, the lens set comprises a first lens and a second lens.

The first lens is used for refracting a light, so as to generate a refracted light substantially parallel to an optical axis of the first lens. The second lens is used for focusing the refracted light and then projecting the refracted light to the webcam. The combination of the lens set and the webcam has a second focal length smaller than the first focal length.

The lens set according to the invention can be adapted to a webcam. When a user desires to capture a partial image at a short distance, the focal length of the webcam can be adjusted by utilizing the lens set, so as to make the partial image become acquirable. Besides, because the lens set according to the invention can be adapted to a built-in webcam of a laptop, data captured by the webcam can be directly transmitted to the laptop, and therefore it is more convenient for the user.

The advantage and spirit of the invention may be understood by the following recitations together with the appended drawings.

### BRIEF DESCRIPTION OF THE APPENDED DRAWINGS

FIG. 1 is a schematic diagram illustrating a capturing mode of a webcam in prior art.

FIG. 2 is a schematic diagram illustrating a lens set according to a preferred embodiment of the invention.

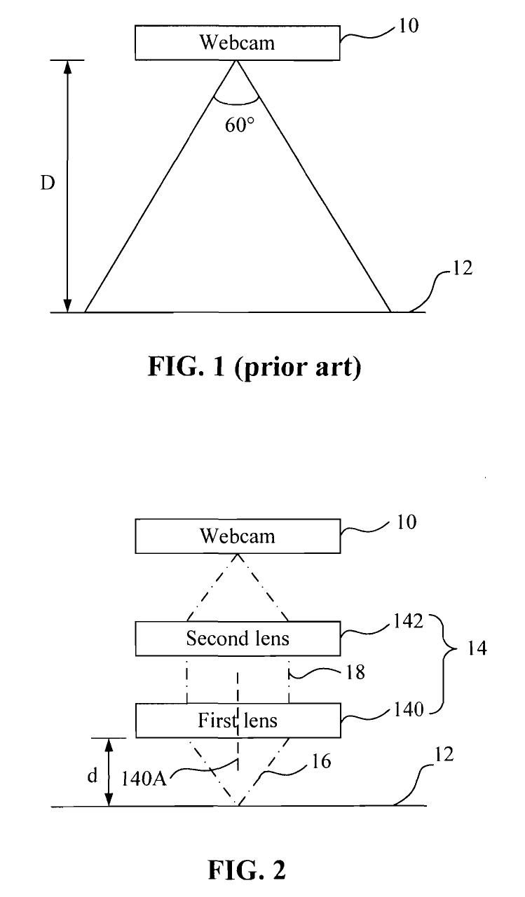

### DETAILED DESCRIPTION OF THE INVENTION

Please refer to FIG. 2. FIG. 2 is a schematic diagram illustrating a lens set 14 according to a preferred embodiment of the invention. The webcam 10 has a first focal length D. As shown in FIG. 2, the lens set 14 comprises a first lens 140 and a second lens 142. A light 16 is emitted from a part of the image 12.

The first lens 140 is used for refracting the light 16, so as to generate a refracted light 18 substantially parallel to an optical axis 140A of the first lens 140. The second lens 142 is used for focusing the refracted light 18 and then projecting the refracted light 18 to the webcam 10. Consequently, a combination of the lens set 14 and the webcam 10 has a second focal length d, and the second focal length d is smaller than the first focal length D. As mentioned above, the webcam 10 itself is unable to capture a part of the image 12 at the distance D. However, when the webcam 10 cooperates with the lens set 14, the webcam 10 can capture a part of the image 12 at a short distance d.

In practical application, a gap between the first lens 140 and the second lens 142 is adjustable, and thereby the second focal length d is adjustable.

In an embodiment, the lens set 14 further comprises a sleeve (not shown in FIG. 2). The first lens 140 and the second lens 142 are disposed within the sleeve and respectively close to a first end and a second end of the sleeve.

In practical application, the sleeve can comprises a coupling member for coupling the lens set 14 to the webcam 10. For example, the coupling member can be a hook for hanging the lens set 14 on the webcam 10. In addition, the coupling member can comprise a screw for fixing the lens set 14 on the webcam 10.

The lens set according to the invention can be adapted to a webcam. When a user desires to capture a partial image at a short distance, the focal length of the webcam can be adjusted by utilizing the lens set, so as to make the partial image become acquirable. Besides, because the lens set according to the invention can be adapted to a built-in webcam of a laptop, data captured by the webcam can be directly transmitted to the laptop, and therefore it is more convenient for the user.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A lens set adapted to a webcam, the webcam having a first focal length, the lens set comprising:
a first lens for refracting a light to generate a refracted light substantially parallel to an optical axis of the first lens; and
a second lens for focusing the refracted light and then projecting the refracted light to the webcam;
wherein a combination of the lens set and the webcam has a second focal length smaller than the first focal length.

2. The lens set of claim 1, wherein a gap between the first lens and the second lens is adjustable, and thereby the second focal length is adjustable.

3. The lens set of claim 1, further comprising:
a sleeve, the first lens and the second lens being disposed within the sleeve and being respectively close to a first end and a second end of the sleeve.

4. The lens set of claim 3, wherein the sleeve has a coupling member for coupling the lens set to the webcam.
